(19) United States
(12) Patent Application Publication
(10) Pub. No.: US 2026/0066845 A1
(43) Pub. Date: Mar. 5, 2026

(54) MODULAR ELECTRICAL BALANCE OF SYSTEMS (EBOS) TRUNK SOLUTION

(71) Applicant: Bentek Corporation, San Jose, CA (US)

(72) Inventor: ChunJu Chen, San Jose, CA (US)

(21) Appl. No.: 19/319,294

(22) Filed: Sep. 4, 2025

Related U.S. Application Data
(60) Provisional application No. 63/690,946, filed on Sep. 5, 2024.

(51) Int. Cl. H02S 40/36; H02S 40/34

(52) U.S. Cl. CPC H02S 40/36; H02S 40/34

(57) ABSTRACT

In one or more embodiments, modular electrical balance of systems (EBOS) trunk solution and a method for providing modular electrical balance of systems (EBOS) trunk solution are disclosed. In an embodiment, the modular electrical balance of systems (EBOS) trunk solution includes a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

### RELATED APPLICATIONS

This application claims the benefit of U.S. Provisional Patent Application No. 63/690,946, filed Sep. 5, 2024, the entire contents of which are incorporated herein by reference.

### FIELD OF THE INVENTION

The embodiments described herein relate generally to electrical connectors and more particularly to modular electrical balance of systems (EBOS) trunk solution.

### SUMMARY

In one or more embodiments, modular electrical balance of systems (EBOS) trunk solution and a method for providing modular electrical balance of systems (EBOS) trunk solution are disclosed.

In an embodiment, the modular electrical balance of systems (EBOS) trunk solution includes a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

In an embodiment, the modular electrical balance of systems (EBOS) trunk solution further includes at least one trunk-branch wire connector middle module, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module.

In one or more embodiments, the modules of the modular electrical balance of systems (EBOS) trunk solution and the disconnect box further include one or more connector ends, wherein the connector ends are configured to be male or female connector ends such that they can be connected to form an electrical connection.

In an embodiment, the method for providing a modular electrical balance of systems (EBOS) trunk solution, the method includes providing a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

In an embodiment, the method for providing a modular electrical balance of systems (EBOS) trunk solution further includes providing at least one trunk-branch wire connector middle module, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module.

In one or more embodiments, the method further includes providing the modules of the modular electrical balance of systems (EBOS) trunk solution and the disconnect box with one or more connector ends, wherein the connector ends are configured to be male or female connector ends such that they can be connected to form an electrical connection.

### BRIEF DESCRIPTION OF THE DRAWINGS

FIG. 1 illustrates an example traditional photovoltaic (PV) source connect to the string combiner box by home run harness.

FIG. 2 illustrates an example modular electrical balance of systems (EBOS) trunk solution 200 according to one or more embodiments described herein.

FIG. 3A illustrates an example modular electrical balance of systems (EBOS) trunk solution 300 according to one or more embodiments described herein.

FIG. 3B illustrates an example modular electrical balance of systems (EBOS) trunk solution 300 according to one or more embodiments described herein.

FIG. 4 illustrates an example module 3 400 including that may be used for configuring the modular electrical balance of systems (EBOS) trunk solution according to one or more embodiments described herein.

FIG. 5 illustrates an example module 4 500 that may be used for configuring the modular electrical balance of systems (EBOS) trunk solution according to one or more embodiments described herein.

FIG. 6 illustrates an example modular electrical balance of systems (EBOS) trunk solution 600 according to one or more embodiments described herein.

FIG. 7A illustrates is an example method 700 for providing a modular electrical balance of systems (EBOS) trunk solution according to one or more embodiments described herein.

FIG. 7B illustrates is an example method 700′ for providing a modular electrical balance of systems (EBOS) trunk solution according to one or more embodiments described herein.

### DETAILED DESCRIPTION

The embodiments described herein relate generally to electrical connectors and more particularly to modular electrical balance of systems (EBOS) trunk solution.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Large-scale solar power plants are flourishing due to the growing demand for clean energy, with an increasing number of plant construction projects entering the market. According to statistics, as the capacity of individual solar power plants continues to increase, both labor and Electric Balance of System (EBOS) costs also increase.

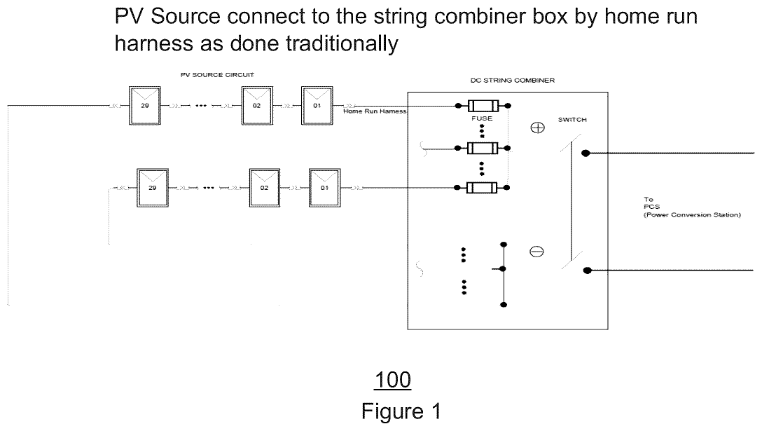

Various methods were used to connect solar panels to a combiner box through Home Run Harness as illustrated in FIG. 1, for example, multiple redundant lines were traditionally used to connect solar panels. Additionally, the fuse was located in the combiner box as illustrated in FIG. 1. These traditional approaches may also lead to the issue of overheating faults in the fuse inside the combiner box.

The following embodiments described herein are unique and improved methods for providing a modular electrical balance of systems (EBOS) trunk solution and modular electrical balance of systems (EBOS) trunk solution that can physically and electrically connect two or more solar panels to overcome the above-mentioned issues.

The embodiments described herein disclose modular electrical balance of systems (EBOS) trunk solution and a method for providing modular electrical balance of systems (EBOS) trunk solution.

In an embodiment, the modular electrical balance of systems (EBOS) trunk solution includes a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

In an embodiment, the modular electrical balance of systems (EBOS) trunk solution further includes at least one trunk-branch wire connector middle module, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module.

In one or more embodiments, the modules of the modular electrical balance of systems (EBOS) trunk solution and the disconnect box further include one or more connector ends, wherein the connector ends are configured to be male or female connector ends such that they can be connected to form an electrical connection.

In an embodiment, the method for providing a modular electrical balance of systems (EBOS) trunk solution, the method includes providing a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

In an embodiment, the method for providing a modular electrical balance of systems (EBOS) trunk solution further includes providing at least one trunk-branch wire connector middle module, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module.

In one or more embodiments, the method further includes providing the modules of the modular electrical balance of systems (EBOS) trunk solution and the disconnect box with one or more connector ends, wherein the connector ends are configured to be male or female connector ends such that they can be connected to form an electrical connection.

The purpose of this system and method is to replace multiple redundant lines traditionally used to connect solar panels to a combiner box through Home Run Harness by a single main Trunk Bus, and moving the fuse located inside the combiner box to the harness side, thus addressing the issue of overheating faults in the fuse inside the combiner box.

Currently, there are two main approaches to trunk bus systems on the market which include prefabrication of the trunk bus system in a factory and on-site installation of the trunk bus system.

The prefabrication in manufactory involves pre-connecting main trunk and branch harness wire in the factory, typically using over-mold technology to encapsulate connectors. The entire trunk wire reel (including connectors) is then sent to the site for wiring and installation. This system has an advantage of high reliability and fast on-site installation.

However, since it is pre-manufactured a whole reel in the factory, there is no flexibility for on-site modifications. If there is a discrepancy in the estimated length of the wire and the actual site conditions, the trunk wire cannot be installed, requiring the entire reel of wire to be remade at the factory, leading to longer wait times. Additionally, the weight of the reel, especially for trunk wire mainly with a diameter of 500 MCM or more, makes on-site wiring challenging.

The on-site installation includes using piercing connectors, the main trunk and branch harness wires are connected on-site. This system allows for flexible installation on-site, however, because the components are installed on-site, there is a risk of poor construction quality leading to connection issues. Furthermore, the on-site installation of connectors may take longer time and result in higher labor cost.

Embodiments described herein propose an innovative modular connection method, coupled with a wire compression connection technology, for example, an Insulation Piercing Electrical Connector, to effectively improve connection reliability while still maintaining on-site installation flexibility. A person skilled in the art may readily understand that although the invention is described using an insulation piercing connector, other products providing similar functionality may also be used and is within the spirit and scope of this invention.

The present invention as claimed may allow for flexibility for on-site modifications, in case of discrepancy in the estimated length of the wire and the actual site conditions. Similarly, the present invention as claimed may also allow for shorter time of installation and lower cost of labor, with higher construction quality.

For example, the invention as claimed, may offer click-and-go installation in the field, it not only saves the installation time but also can be without the need to hire a licensed electrician. Therefore, the labor cost can be significantly reduced.

Additionally, it may offer a high on-site installation flexibility as the modular design may make the system become flexible. The modules can be set in any location the site need. If there is any length design change during the installation, a section of trunk wire with connector may be replaced easily without a need to replace other components. This can reduce any installation downtime and may also save the material cost.

Another advantage is easy inventory, manufacturing and shipping. With modular design, each component can be a smaller piece compared to the current pre-fabricated trunk system. This may make the manufacturing and handling of the components easier. The modular product may also be provided as a standard product instead of fully customized product, which is beneficial for managing the inventory. A standard product means one can be sell it to anyone, everywhere, and can be produced ahead of time and be available when the customer needs it. Each component also easily for shipping and storage due to its smaller size.

The Modular EBOS Trunk Solution may also offer high reliability since each component of the system may be prefabricated in the manufacturing facility, it is easier to maintain the quality of the product.

The Modular EBOS Trunk Solution may also enhance replaceability, replace individual components, and reduce maintenance costs. The modular product is easy to replace as only the items that are faulty need to be changed. This can reduce the maintenance and replacement cost.

The Modular EBOS Trunk Solution described herein includes a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

In an embodiment, the modular electrical balance of systems (EBOS) trunk solution may further include at least one trunk-branch wire connector middle module wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module.

The solar module that connects to the trunk-branch wire connector end module may be different from the one that connects to the at least one trunk-branch wire connector middle module.

A branch wire may be defined as a wire for connecting the Modular EBOS Trunk Solution to the solar panel and may usually be a 6 AWG to 10 AWG PV wire. A trunk wire may be defined as a wire that transmits solar power from several branch wires and is generally above 500 MCM PV wire.

In one or more embodiments, the modules of the modular electrical balance of systems (EBOS) trunk solution and the disconnect box further include one or more connector ends, wherein the connector ends are configured to be male or female connector ends such that they can be connected to form an electrical connection.

The trunk-branch wire connector can be any connector, such as the connector which connects the trunk and branch wires described in co-pending and co-owned U.S. patent application Ser. No. 18/801,932.

The trunk wire connector may be a readily available product, for example, Staubli or BosCon or any such solar trunk connector. The trunk wire connector may include a female connector at one end and a male connector at the other end that connect different trunk wires together when connected with appropriate male and female connectors respectively.

Trunk wire with connector may be pre-fabricated with customized length of wire attached to a trunk connector as described above, and can be easily connected with Trunk-Branch wire connector module or the Disconnect Box. This provides easy installation as it can be manufactured in a manufacturing facility and connected on site during installation to provide flexibility at the same time.

FIG. 1 illustrates an example traditional PV Source connect to the string combiner box by home run harness. For example, the traditional system 100 shows multiple redundant lines traditionally used to connect solar panels to the combiner box through Home Run Harness as well as a fuse located in the combiner box.

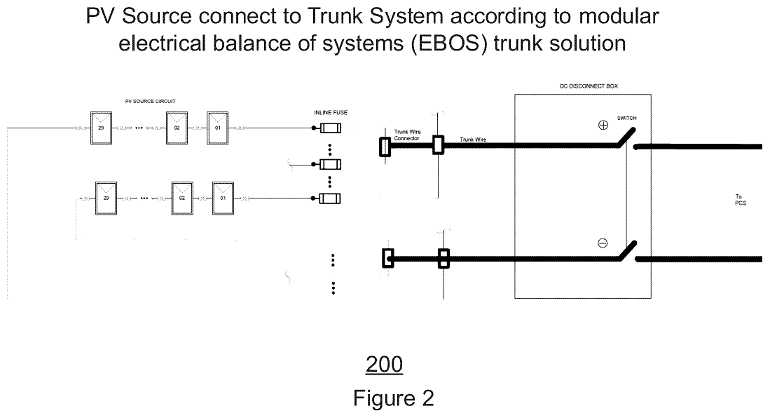

FIG. 2 illustrates an example modular electrical balance of systems (EBOS) trunk solution according to one or more embodiments described herein. For example, the modular electrical balance of systems (EBOS) trunk solution 200 illustrates multiple redundant lines traditionally used to connect solar panels to the combiner box through Home Run Harness are replaced by a single main Trunk Bus. Additionally, the fuse located in the combiner box are moved to the line side. This approach effectively reduces the number of lines and the labor cost associated with wiring, while addressing the issue of overheating faults in the fuse inside the combiner box.

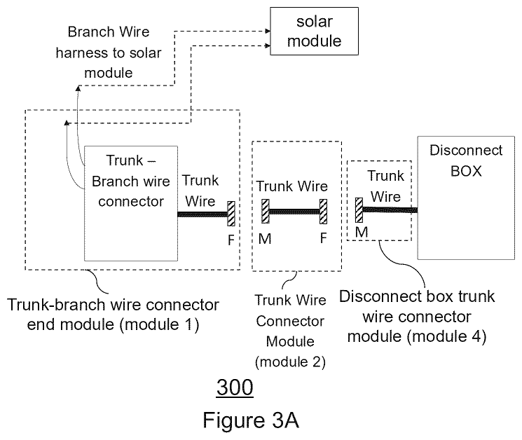

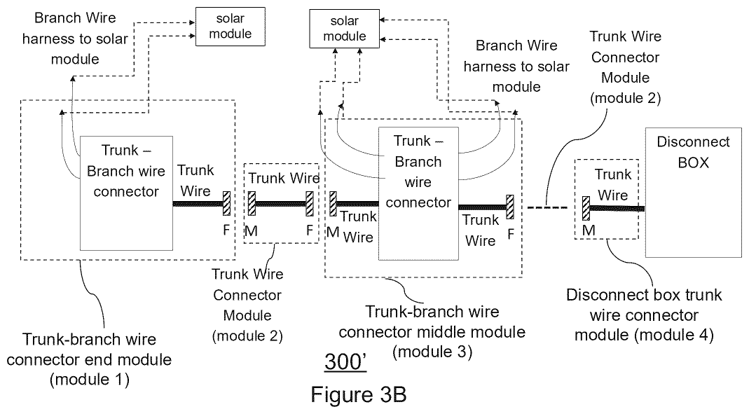

FIG. 3A illustrates an example modular electrical balance of systems (EBOS) trunk solution 300 according to one or more embodiments described herein. For example, in an embodiment, the modular electrical balance of systems (EBOS) trunk solution includes a solar module, a trunk-branch wire connector end module, at least one trunk wire connector module, a disconnect box trunk wire connector module, and a disconnect box, wherein the trunk-branch wire connector end module is connected to the solar module and wherein the disconnect box trunk wire connector module is connected to the disconnect box.

FIG. 3B illustrates an example modular electrical balance of systems (EBOS) trunk solution 300′ according to one or more embodiments described herein. As illustrated in FIG. 3B, in an embodiment, the modular electrical balance of systems (EBOS) trunk solution may further include at least one trunk-branch wire connector middle module, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to the solar module. Although only one middle module (module 3) is shown here, it is illustrated as an example only, and more than one middle module may be connected as needed.

The solar module that connects to the trunk-branch wire connector end module may be different from the one that connects to the at least one trunk-branch wire connector middle module as illustrated in FIG. 3B.

In one or more embodiments, the modules of the modular electrical balance of systems (EBOS) trunk solution and the disconnect box further include one or more connector ends, wherein the connector ends are configured to be male or female connector ends such that they can be connected to form an electrical connection.

For example, module 1 described herein may include trunk-branch wire connector, a branch wire, a trunk wire and a trunk wire connector, for example, female connector. Since module 1 is used as an end module, it has only one side with wire and connector as illustrated in FIGS. 3A and 3B.

Module 2 described herein may include a trunk wire, trunk wire connector, for example, a female connector and a trunk wire connector, for example, a male connector. Since module 2 may be located between module 1 and module 3, and/or module 3 and module 4, as illustrated in FIG. 3B, the trunk wire length can be flexible and may be customized to match the solar field as needed.

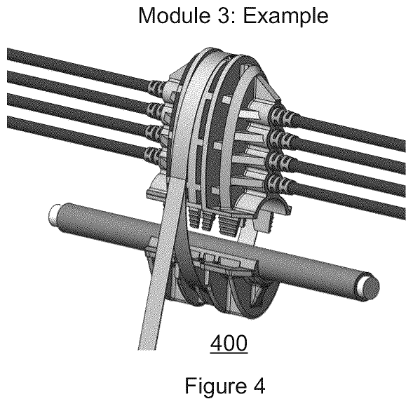

Module 3 described herein may include a trunk-branch wire connector, which may be connected to one or more branch wires, and a trunk wire connected to a trunk wire connector, for example, a female connector on one side and a trunk wire connector, for example, a male connector on the other side. An example module 3 including a trunk-branch wire connector 400 is illustrated in FIG. 4.

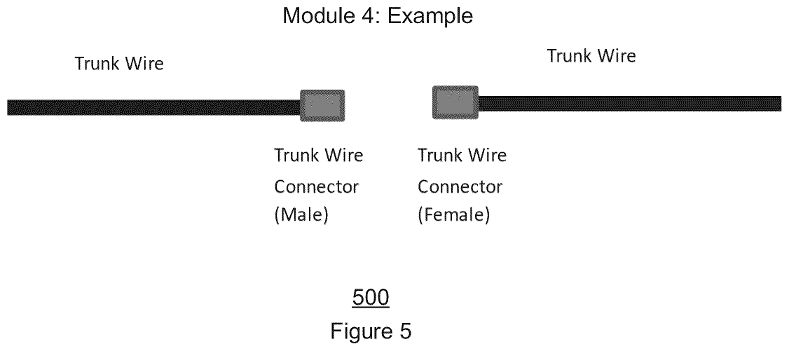

Module 4 described herein may include a trunk wire with a trunk wire connector, for example, a male connector. Since module 4 is the last module that connects the whole modular trunk system to the disconnect box, one side of the module 4 is provided with a connector that can connect to module 1 and/or module 3, and the other side can connect to the disconnect box. An example module 4 including trunk wire with a trunk wire connector 500 is illustrated in FIG. 5.

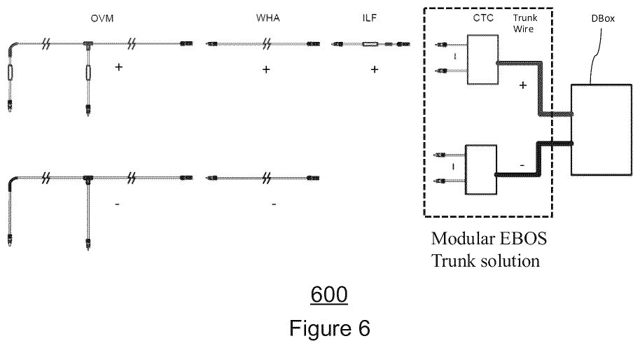

Combination of these modules, the Modular EBOS Trunk Solution, as illustrated in FIGS. 3A and 3B, can offer a complete power transmission system from the solar panel to the disconnect box. FIG. 6 illustrates an example of complete power transmission system 600 using the Modular EBOS Trunk Solution 300 and 300′.

Although the configuration is described with specific male and female connectors, a person skilled in the art may readily understand that the choice of connectors may differ so as to make proper connections to complete the circuit.

FIG. 4 illustrates an example module 3 400 including that may be used for configuring the modular electrical balance of systems (EBOS) trunk solution according to one or more embodiments described herein. For example, the module 3 may include a trunk-branch wire connector, which may be connected to one or more branch wires, and a trunk wire connected to a trunk wire connector, for example, a female connector on one side and a trunk wire connector, for example, a male connector on the other side, that connect different trunk wires or other modules together when connected with appropriate male and female connectors respectively.

FIG. 5 illustrates an example module 4 500 that may be used for configuring the modular electrical balance of systems (EBOS) trunk solution according to one or more embodiments described herein. For example, a module 4 may include a trunk wire with a trunk wire connector, for example, a male connector. Since module 4 is the last module that connects the whole modular trunk system to the disconnect box, one side of the module 4 is provided with a connector that can connect to module 1 and/or module 3, and the other side can connect to the disconnect box.

FIG. 6 illustrates an example of total solution where the modular electrical balance of systems (EBOS) trunk solution 600 replaces the current design according to one or more embodiments described herein. For example, as illustrated in FIG. 6, as used currently, the complete power transmission system 700 includes a disconnect box (for example, a disconnect box, shown here as DBox) that connects the trunk wire into the inverter, a compression trunk connector (CTC) Trunk Module that connects trunk and tap wire, an inline fuse (ILF) installed in Positive side wire to protect the circuit, wire home-run string harness assembly (WHA) that includes a harness to connect an OverMold harness (OVM) or solar module with CTC trunk module tap wire into the trunk system and an OVM that connect several string harness from solar module to reduce the harness cost. According to one or more embodiments described herein and as illustrated in FIG. 6, the Modular EBOS Trunk solution illustrated in FIGS. 3A and 3B can replace the CTC and trunk wire to provide the advantages discussed above.

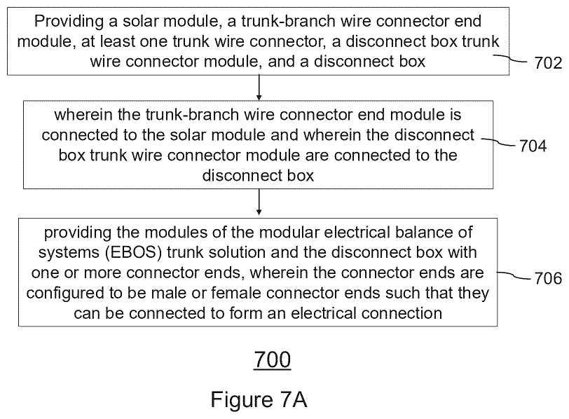

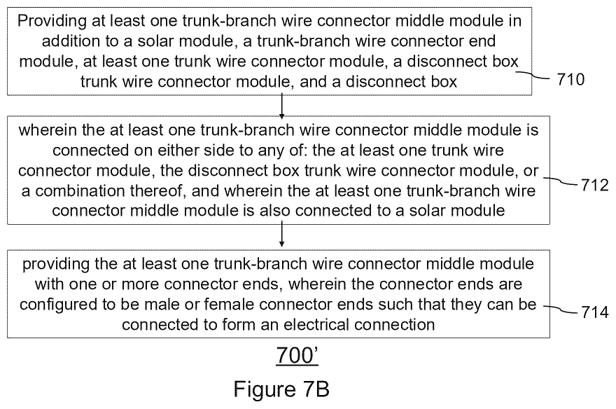

FIG. 7A illustrates is an example method for providing a modular electrical balance of systems (EBOS) trunk solution according to one or more embodiments described herein. For example, in an embodiment, the method for providing a modular electrical balance of systems (EBOS) trunk solution, the method includes providing a solar module, a trunk-branch wire connector end module, at least one trunk wire connector module, a disconnect box trunk wire connector module, and a disconnect box via step 702.

The trunk-branch wire connector end module is connected to the solar module and the disconnect box trunk wire connector module is connected to the disconnect box via step 704.

In one or more embodiments, the method further includes providing the modules of the modular electrical balance of systems (EBOS) trunk solution and the disconnect box with one or more connector ends, wherein the connector ends are configured to be male or female connector ends via step 706, such that they can be connected to form an electrical connection.

FIG. 7B illustrates is an example method for providing a modular electrical balance of systems (EBOS) trunk solution according to one or more embodiments described herein. For example, in an embodiment, the method for providing a modular electrical balance of systems (EBOS) trunk solution further includes providing at least one trunk-branch wire connector middle module via step 710, wherein the at least one trunk-branch wire connector middle module is connected on either side to any of: the at least one trunk wire connector module, the disconnect box trunk wire connector module, or a combination thereof, and wherein the at least one trunk-branch wire connector middle module is also connected to a solar module via step 712.

The solar module that connects to the trunk-branch wire connector end module may be different from the one that connects to the at least one trunk-branch wire connector middle module.

In one or more embodiments, the method further includes providing the at least one trunk-branch wire connector middle module with one or more connector ends, wherein the connector ends are configured to be male or female connector ends via step 714, such that they can be connected to form an electrical connection.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A modular electrical balance of systems (EBOS) trunk solution comprising:
a solar module;
a trunk-branch wire connector end module;
at least one trunk wire connector module;
a disconnect box trunk wire connector module; and
a disconnect box, the trunk-branch wire connector end module being connected to the solar module, the disconnect box trunk wire connector module connected to the disconnect box.

2. The system of claim 1, wherein the modules of the modular electrical balance of systems (EBOS) trunk solution and the disconnect box further include one or more connector ends, the connector ends configured to be male or female connector ends such that they are capable of forming an electrical connection when connected.

3. The system of claim 1, further comprising at least one trunk-branch wire connector middle module, the at least one trunk-branch wire connector middle module connected on either side to any of:
the at least one trunk wire connector module, the disconnect box trunk wire connector module, or a combination thereof, the at least one trunk-branch wire connector middle module further connected to a solar module.

4. The system of claim 3, wherein the at least one trunk-branch wire connector middle module includes one or more connector ends; and wherein
the connector ends are configured to be male or female connector ends such that they are capable of forming an electrical connection when connected.

5. The system of claim 1, wherein the at least one trunk wire connector module comprises:
a trunk wire segment of at least 500 MCM PV wire; and
connectors at opposite ends.

6. The system of claim 1, wherein each of the solar module, the trunk-branch wire connector end module, the at least one trunk wire connector module, and the disconnect box trunk wire connector module includes:
one or more connector ends configured as male connector ends or female connector ends to electrically mate with complementary connector ends of an adjacent module.

7. The system of claim 1, wherein at least one of the connector ends comprises an insulation piercing electrical connector.

8. The system of claim 1, wherein the trunk-branch wire connector modules are comprise modular housings.

9. The system of claim 1, wherein the trunk-branch wire connector end module comprises a branch wire of 6 AWG to 10 AWG PV wire for connecting to the solar module.

10. A modular electrical balance of systems (EBOS) trunk solution comprising:
a plurality of trunk-branch wire connector modules, each configured to electrically connect to a solar module and to a trunk wire;
a plurality of trunk wire connector modules, each comprising a trunk wire segment having connectors at opposite ends;
a disconnect box trunk wire connector module configured to electrically connect to a disconnect box;
and the disconnect box;
wherein each connector comprises a male connector end or a female connector end configured to electrically mate with a complementary connector end of an adjacent module to form a configurable trunk bus extending from the trunk-branch wire connector modules to the disconnect box trunk wire connector module, whereby the solar modules are electrically connected to the trunk bus.

11. The system of claim 10, wherein at least one trunk-branch wire connector module includes an integrated fuse housing physically disposed within the module.

12. The system of claim 10, wherein the trunk wire segments of the trunk wire connector modules are provided in a plurality of predetermined lengths.

13. The system of claim 10, wherein each trunk wire connector module is provided as an individual unit with factory-installed connectors at both ends.

14. The system of claim 10, wherein the trunk-branch wire connector modules include adjustable mounting brackets for attachment to support structures.

15. The system of claim 10, wherein the trunk bus comprises a plurality of trunk wire connector modules joined end-to-end by mating connector ends.

16. A method for providing a modular electrical balance of systems (EBOS) trunk solution, the method comprising:
providing a solar module, a trunk-branch wire connector end module, at least one trunk wire connector module, a disconnect box trunk wire connector module, and a disconnect box; wherein
the trunk-branch wire connector end module is connected to the solar module; and wherein
the disconnect box trunk wire connector module is connected to the disconnect box.

17. The method of claim 16, further comprising providing the modules of the modular electrical balance of systems (EBOS) trunk solution and the disconnect box with one or more connector ends, the connector ends configured to be male or female connector ends such that they are capable of forming an electrical connection when connected.

18. The method of claim 16, further including providing at least one trunk-branch wire connector middle module, the at least one trunk-branch wire connector middle module connected on either side to any of: the at least one trunk wire connector module, the disconnect box trunk wire connector module, or a combination thereof; and
wherein the at least one trunk-branch wire connector middle module is also connected to a solar module.

19. The method of claim 18, further comprising providing the at least one trunk-branch wire connector middle module with one or more connector ends, the connector ends configured to be male or female connector ends such that they are capable of forming an electrical connection when connected.

20. The method of claim 16, further comprising providing each trunk wire connector module with connectors at opposite ends to enable electrical mating with adjacent modules.
